(19) United States
(12) Patent Application Publication
(10) Pub. No.: US 2022/0388801 A1
(43) Pub. Date: Dec. 8, 2022

(54) SHEET CONVEYING APPARATUS AND IMAGE FORMING APPARATUS

(71) Applicant: CANON KABUSHIKI KAISHA, Tokyo (JP)

(72) Inventors: Shingo Iwami, Tokyo (JP); Keisuke Mogi, Chiba (JP); Yuma Inui, Ibaraki (JP)

(21) Appl. No.: 17/825,320

(22) Filed: May 26, 2022

(30) Foreign Application Priority Data
Jun. 8, 2021 (JP) 2021-095600

(51) Int. Cl. B65H 23/34; G03G 15/00; B65H 23/26

(52) U.S. Cl. CPC B65H 23/34; G03G 15/6529; B65H 23/26; B65H 2404/20; B65H 2404/252

(57) ABSTRACT

A sheet conveying apparatus including: a pair of inlet rollers; a pair of outlet rollers; a pair of movable rollers disposed between the inlet rollers and the outlet rollers; a moving unit configured to move the movable rollers; a pair of upstream rollers disposed between the inlet rollers and the movable rollers; a pair of downstream rollers disposed between the movable rollers and the outlet rollers; a first conveyance belt passed over a first inlet roller, a first outlet roller, a first movable roller, a first upstream roller, and a first downstream roller; and a second conveyance belt passed over a second inlet roller, a second outlet roller, a second movable roller, a second upstream roller, and a second downstream roller. A diameter of the pair of upstream rollers and a diameter of the pair of downstream rollers are smaller than a diameter of the pair of movable rollers.

### BACKGROUND OF THE INVENTION

### Field of the Invention

The present invention relates to a sheet conveying apparatus and an image forming apparatus.

### Description of the Related Art

In recent years, image forming apparatuses such as coping machines, printers, and facsimiles using an electrophotographic printing method have become widespread. Sheets on which images have been formed by the image forming apparatuses may be stacked in large quantities on trays or delivered to in-line or off-line post-processing apparatuses for saddle-stitching, stapling, or other bookbinding processes. A curl may occur on a sheet on which an image has been formed using the electrophotographic printing method. For example, when a sheet is heated and pressurized by a fixing device to fix a toner image to the sheet, a heat curl may occur on the sheet. When a toner shrinks, a toner curl may occur on the sheet. Further, when a sheet passes through a bent sheet conveying path, a conveying path curl may occur on the sheet. If a curl occurring on a sheet is large, there is a possibility that a failure such as poor stacking, poor alignment, and poor stapling of the sheet may occur in a post-processing apparatus.

In order to solve such a problem, there is an image forming apparatus provided with a curl correcting device configured to correct a curl occurring on a sheet. For example, Japanese Patent Application Laid-Open No. 2001-294355 discloses a curl correcting device comprising an endless belt passed over a drive roller and a driven roller, and a rotatable pressing roller pressed against a belt surface of the endless belt. A sheet conveying path is formed in a pressure contact portion (belt nip portion) between the endless belt and the pressing roller. The sheet conveying path is curved by the pressing roller being pressed against the endless belt. The curl of the sheet is corrected by passing the sheet through the curved sheet conveying path (belt nip portion).

The curl correcting device disclosed in the Japanese Patent Application Laid-Open No. 2001-294355 corrects a sheet curled in a predetermined curl direction in one direction (correction direction). However, the curl direction of the sheet on which the image is formed is not only the one direction. In particular, according to variable printing in digital printing, different images are printed for each sheet, so that different curls may occur for each sheet. Then, Japanese Patent Application Laid-Open No. H08-165049 discloses a curl correcting device configured to correct curls in both directions. In the configuration, the correction direction can be changed by moving a pair of pressing rollers sandwiching a pair of belts. In addition, since the sheet is nipped by the pair of belts regardless of the correction direction, the stable conveyance is ensured during a curl correction.

However, as disclosed in Japanese Patent Application Laid-Open No. 2001-294355 or Japanese Patent Application Laid-Open No. H08-165049, in the configuration in which the pressing rollers are pressed against the belts to correct the curl of the sheet, the greater the curl amount of the sheet, the greater the amount of pushing the pressing rollers onto the belts. FIG. 13 is a view of a conventional curl correcting device 70. The curl correcting device 70 has a pair of conveyance belts 72a and 72b sandwiching a sheet conveying path 71 therebetween, and a pair of pressing rollers 73a and 73b arranged so as to sandwich the pair of conveyance belts 72a and 72b therebetween. The conveyance belt 72a is passed over a drive roller 74a, a driven roller 75a, and a driven roller 76a. The conveyance belt 72b is passed over driven rollers 74b, 75b and 76b. The sheet S is conveyed from upstream guides 77a and 77b to downstream guides 78a and 78b through the sheet conveying path 71 in a sheet conveying direction V.

As shown in FIG. 13, when the pair of pressing rollers 73a and 73b are moved in an upward direction U in order to correct the curl of the sheet S, the sheet conveying path 71 is deformed upward. In order to correct the large curl amount of the sheet S, it is necessary to increase a contact angle of the pair of conveyance belts 72a and 72b around the pressing roller 73b. In order to increase the contact angle, it is necessary to increase a moving amount of the pair of pressing rollers 73a and 73b in the upward direction U. However, when the moving amount is increased, a moving time of the pair of pressing rollers 73a and 73b becomes longer so that the productivity decreases. In the conventional curl correcting device 70 shown in FIG. 13, when the moving amount of the pair of pressing rollers 73a and 73b toward the upward direction U is increased, a bending amount of the sheet conveying path 71 around the drive roller 74a on the downstream side is also increased. A bending direction of the sheet conveying path 71 around the drive roller 74a is opposite to a bending direction for correcting the curl, which lowers the curl correcting ability.

### SUMMARY OF THE INVENTION

A sheet conveying apparatus according to an embodiment of the present invention, the sheet conveying apparatus comprising:

a pair of inlet rollers;

a pair of outlet rollers;

a pair of movable rollers disposed between the pair of inlet rollers and the pair of outlet rollers in a sheet conveying direction from the pair of inlet rollers toward the pair of outlet rollers, the pair of movable rollers being movable in a first direction orthogonal to the sheet conveying direction and rotation axes of the pair of movable rollers and in a second direction opposite to the first direction;

a moving unit configured to move the pair of movable rollers in the first direction and in the second direction;

a pair of upstream rollers disposed between the pair of inlet rollers and the pair of movable rollers in the sheet conveying direction;

a pair of downstream rollers disposed between the pair of movable rollers and the pair of outlet rollers in the sheet conveying direction;

a first conveyance belt passed over a first inlet roller of the pair of inlet rollers, a first outlet roller of the pair of outlet rollers, a first movable roller of the pair of movable rollers, a first upstream roller of the pair of upstream rollers, and a first downstream roller of the pair of downstream rollers; and

a second conveyance belt disposed opposite to the first conveyance belt to form a sheet conveying path and passed over a second inlet roller different from the first inlet roller of the pair of inlet rollers, a second outlet roller different from the first outlet roller of the pair of outlet rollers, a second movable roller different from the first movable roller of the pair of movable rollers, a second upstream roller different from the first upstream roller of the pair of upstream rollers, and a second downstream roller different from the first downstream roller of the pair of downstream rollers,

wherein a diameter of the pair of upstream rollers and a diameter of the pair of downstream rollers are smaller than a diameter of the pair of movable rollers.

Further features of the present invention will become apparent from the following description of exemplary embodiments with reference to the attached drawings.

### BRIEF DESCRIPTION OF THE DRAWINGS

FIG. 1 is a cross-sectional view of an image forming apparatus.

FIG. 2 is a view of a curl correcting device of a first embodiment.

FIG. 3A, FIG. 3B, and FIG. 3C are explanatory views of curls occurring on sheets.

FIG. 4A and FIG. 4B are explanatory views of movements of a pair of movable rollers.

FIG. 5A, FIG. 5B, and FIG. 5C are explanatory views of a moving amount of the pair of movable rollers and a contact angle of conveyance belts.

FIG. 6 is a block diagram of a controller of the first embodiment.

FIG. 7 is a flowchart illustrating an operation of the curl correcting device of the first embodiment.

FIG. 8 is a view of a curl correcting device of a second embodiment.

FIG. 9 is a block diagram of a controller of the second embodiment.

FIG. 10 is a flowchart illustrating an operation of the curl correcting device of the second embodiment.

FIG. 11A and FIG. 11B are block diagrams of controllers of modification examples of the second embodiment.

FIG. 12A and FIG. 12B are views of a curl correcting device of a comparative example.

FIG. 13 is a view of a conventional curl correcting device.

### DESCRIPTION OF THE EMBODIMENTS

Hereinafter, the embodiments of the present invention will be described with reference to the accompanying drawings.

### First Embodiment

### (Image Forming Apparatus)

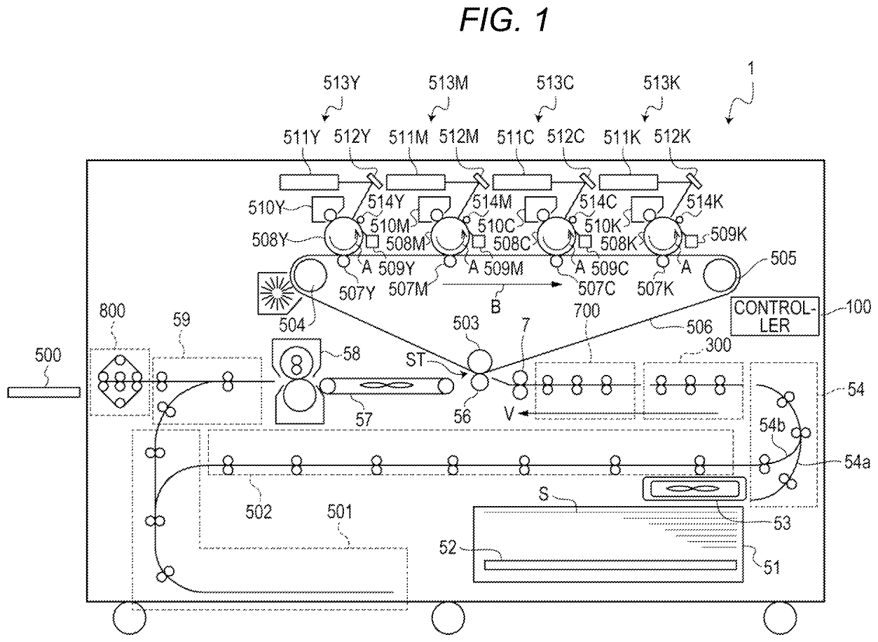

FIG. 1 is a cross-sectional view of an image forming apparatus 1. The image forming apparatus 1 includes a curl correcting device (sheet conveying apparatus) 800. First, the overall configuration of the image forming apparatus 1 will be described. In the embodiment, the image forming apparatus 1 is an electrophotographic digital full-color printer that forms an image on a recording medium (hereinafter referred to as a sheet) S by using a plurality of color toners. The image forming apparatus 1 is a tandem system in which a plurality of image forming portions 513Y, 513M, 513C, and 513K are arranged side by side. However, the image forming apparatus 1 may be a rotary system in which a rotary member holding a plurality of developing devices is rotated to form toner images of respective colors on one photosensitive member. The image forming apparatus 1 is an intermediate transfer system in which toner images are temporarily transferred from a plurality of photosensitive drums (hereinafter referred to as photosensitive members) 508Y, 508M, 508C and 508K to an intermediate transfer belt 506 as an intermediate transfer member, and then transferred to a sheet S. However, the image forming apparatus 1 may be a direct transfer system in which respective toner images are directly transferred from the plurality of photosensitive members 508Y, 508M, 508C and 508K to a sheet S. Since the intermediate transfer system does not require holding the sheet S on a transfer drum or a transfer belt as in the direct transfer system, the intermediate transfer system can cope with a wide variety of sheets S such as super thick paper and coated paper. The intermediate transfer system is suitable for realizing high productivity by the features of parallel processing in the plurality of image forming portions 513Y, 513M, 513C, and 513K and the collective transfer of full-color images.

An image forming portion 513Y forms a yellow toner image by using yellow toner. An image forming portion 513M forms a magenta toner image by using magenta toner. An image forming portion 513C forms a cyan toner image by using the cyan toner. An image forming portion 513K forms a black toner image by using black toner. The suffixes Y, M, C, and K attached to the reference numerals indicate yellow, magenta, cyan, and black, respectively. In the following description, the suffixes Y, M, C, and K attached to the reference numerals may be omitted when not particularly necessary. The four image forming portions 513 have the same structure except for the color of the developer (toner).

The image forming portion 513 includes a photosensitive member 508, a charging roller 514, an exposure device 511, a developing device 510, a primary transfer device 507, and a photosensitive member cleaner 509. An endless intermediate transfer belt 506 is disposed below the photosensitive member 508. The intermediate transfer belt 506 is stretched over a drive roller 504, a tension roller 505, and a secondary transfer inner roller 503. The intermediate transfer belt 506 rotates in a rotation direction B indicated by the arrow in FIG. 1 during image formation. The primary transfer device 507 is disposed opposite to the photosensitive member 508 through the intermediate transfer belt 506. The primary transfer device 507 transfers the toner image on the surface of the photosensitive member 508 to the intermediate transfer belt 506. A secondary transfer outer roller 56 is disposed opposite to the secondary transfer inner roller 503 through the intermediate transfer belt 506. A secondary transfer portion (toner image transfer nip portion) ST is formed between the intermediate transfer belt 506 and the secondary transfer outer roller 56.

A sheet cassette 51 configured to contain sheets S is disposed in a lower portion of the image forming apparatus 1. The sheets S are stacked on a lift-up device 52 provided in the sheet cassette 51. A feeding device 53 feeds a sheet S from the sheet cassette 51 in accordance with an image forming timing of the image forming apparatus 1. The feeding device 53 uses a sheet feeding system by air. However, the feeding device 53 may use a system utilizing friction separation by a feeding roller, a system utilizing separation and adsorption by air, or other systems. The sheet S fed by the feeding device 53 is conveyed to a conveyance portion 300 through a conveying path 54a of a conveying unit 54. The sheet S is conveyed from the conveyance portion 300 to a skew correction portion 700 in a sheet conveying direction V. The skew correction portion 700 corrects the skew of the sheet S. A registration roller 7 is disposed downstream of the skew correction portion 700. The registration roller 7 conveys the sheet S to the secondary transfer portion ST at a predetermined timing. The secondary transfer portion ST transfers the toner image on the intermediate transfer belt 506 to the sheet S by applying a predetermined pressure and an electrostatic load bias to the sheet S.

A pre-fixing sheet conveying device 57 is disposed downstream of the secondary transfer portion ST in the sheet conveying direction V. A fixing device 58 is disposed downstream of the pre-fixing sheet conveying device 57. The sheet S to which the toner image has been transferred by the secondary transfer portion ST is conveyed to the fixing device 58 by the pre-fixing sheet conveying device 57. The fixing device 58 has a heating roller or a heating belt provided with a heat source such as a heater, and a pressure roller or a pressure belt arranged opposite to the heating roller or the heating belt. The fixing device 58 heats and pressurizes the sheet S to melt the toner to fix the toner image to the sheet S.

A branch conveying device 59 is provided downstream of the fixing device 58 in the sheet conveying direction V. The branch conveying device 59 switches a conveying destination of the sheet S to which the toner image has been fixed by the fixing device 58 to a curl correcting device 800 or a reverse conveying device 501 disposed downstream of the branch conveying device 59. In a case of a simplex printing, the branch conveying device 59 conveys the sheet S having the image formed on the first surface thereof to the curl correcting device 800. In a case of a duplex printing, the branch conveying device 59 conveys the sheet S having the image formed on the first surface thereof to the reverse conveying device 501. The reverse conveying device 501 reverses the first surface and the second surface of the sheet S and conveys the sheet S to a duplex conveying device 502. The duplex conveying device 502 conveys the sheet S to a conveying path 54b of the conveying unit 54. The sheet S is conveyed again to the secondary transfer portion ST so that an image is formed on the second surface of the sheet S, and then, the sheet S is conveyed to the curl correcting device 800. The curl correcting device 800 corrects the curl of the sheet S on which the image is formed. The sheet S on which the image is formed is discharged to a discharge tray 500.

### (Image Forming Process)

Next, an image forming process of the image forming apparatus 1 will be described. Since the image forming processes of the four image forming portions 513Y, 513M, 513C and 513K are the same, an image forming process of the image forming portion 513Y configured to form a yellow toner image will be described. The description of the image forming processes of the image forming portions 513M, 513C and 513K is omitted.

The photosensitive member 508Y is rotated in a rotation direction A indicated by the arrow in FIG. 1. The charging roller 514Y uniformly charges the surface of the photosensitive member 508Y. The exposure device 511Y emits a light beam modulated according to a signal of image information of a yellow component. The light beam is reflected by a reflecting mirror 512Y to form an electrostatic latent image on the surface of the photosensitive member 508Y. The developing device 510Y develops the electrostatic latent image with yellow toner (developer) to form a yellow toner image. An electrostatic load bias is applied to the primary transfer device 507Y to transfer the yellow toner image on the photosensitive member 508Y to the intermediate transfer belt 506. The photosensitive member cleaner 509Y collects toner remaining slightly on the photosensitive member 508Y after transfer.

Similarly, a magenta toner image formed by the image forming portion 513M is accurately superimposed and transferred on the yellow toner image on the intermediate transfer belt 506. A cyan toner image formed by the image forming portion 513C is accurately superimposed and transferred on the magenta toner image on the intermediate transfer belt 506. A black toner image formed by the image forming portion 513K is accurately superimposed and transferred onto the cyan toner image on the intermediate transfer belt 506. As a result, the toner images of the four colors are superimposed on the intermediate transfer belt 506. The toner images of the four colors superimposed on the intermediate transfer belt 506 are conveyed to the secondary transfer portion ST by rotation of the intermediate transfer belt 506 in the rotation direction B.

A sheet S conveyed from the sheet cassette 51 is conveyed to the secondary transfer portion ST by the registration roller 7 so that a leading end of the sheet S coincides with a leading end of the toner images on the intermediate transfer belt 506 at the secondary transfer portion ST. The toner images on the intermediate transfer belt 506 are collectively transferred onto the sheet S by the secondary transfer portion ST. The sheet S to which the toner images have been transferred is conveyed to the fixing device 58 by the pre-fixing sheet conveying device 57. The fixing device 58 fixes the toner images to the sheet S, thereby forming a full-color image on the sheet S. The sheet S on which the image is formed is conveyed by the branch conveying device 59 to the curl correcting device 800 or the reverse conveying device 501. The curl correcting device 800 corrects the curl of the sheet S and discharges the sheet S to the discharge tray 500.

In the embodiment, the curl correcting device 800 is disposed downstream of the branch conveying device 59 with respect to the sheet conveying direction V. However, the embodiment is not limited to this. The curl correcting device 800 may be disposed upstream of the branch conveying device 59 with respect to the sheet conveying direction V.

### (Curl Correcting Device of Comparative Example)

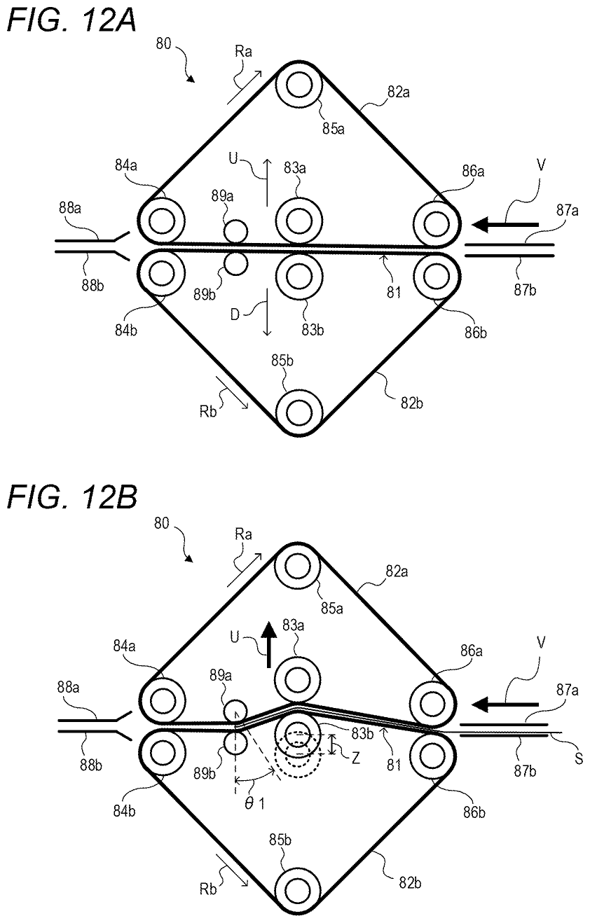

Before describing the curl correcting device 800 of the first embodiment, a curl correcting device 80 of a comparative example will be described with reference to FIG. 12A and FIG. 12B. FIG. 12A and FIG. 12B are views of the curl correcting device 80 of the comparative example. The curl correcting device 80 has a pair of conveyance belts 82a and 82b that form a sheet conveying path 81 therebetween, and a pair of movable rollers 83a and 83b disposed so as to sandwich the pair of conveyance belts 82a and 82b. The conveyance belt 82a is passed over the movable roller 83a, a drive roller 84a, a driven roller 85a, and a driven roller 86a, and is rotatable in a rotation direction Ra indicated by the arrow. The conveyance belt 82b is passed over the movable roller 83b and a driven rollers 84b, 85b, and 86b, and is rotatable in a rotation direction Rb indicated by the arrow. A pair of downstream rollers 89a and 89b are arranged so as to sandwich the pair of conveyance belts 82a and 82b downstream of the pair of movable rollers 83a and 83b in the sheet conveying direction V. A diameter of the pair of downstream rollers 89a and 89b is smaller than a diameter of the pair of movable rollers 83a and 83b. The sheet S is conveyed in the sheet conveying direction V from between a pair of upstream guides 87a and 87b to between a pair of downstream guides 88a and 88b through the sheet conveying path 81.

The pair of movable rollers 83a and 83b are movable in an upward direction (first direction) U and a downward direction (second direction) D orthogonal to the sheet conveying direction V. FIG. 12A is a view of the curl correcting device 80 when the pair of movable rollers 83a and 83b are positioned in an initial position so that the sheet conveying path 81 is linear. Each of the pair of downstream rollers 89a and 89b is a small-diameter roller having a large curvature to correct the curl of the sheet S. The pair of downstream rollers 89a and 89b are fixed so as not to move in the upward direction U and the downward direction D, and are rotatable according to the rotation of the pair of conveyance belts 82a and 82b.

In order to correct the curl of the sheet S, the pair of movable rollers 83a and 83b, which are larger in diameter than the pair of downstream rollers 89a and 89b, are moved in the upward direction U or the downward direction D in accordance with the correction direction. FIG. 12B is a view of the curl correcting device 80 in which the pair of movable rollers 83a and 83b are moved in the upward direction U. The pair of conveyance belts 82a and 82b are wound around the first downstream roller 89a. By changing a moving amount of the pair of movable rollers 83a and 83b in the upward direction U, a contact angle θ1 of the pair of conveyance belts 82a and 82b wound around the first downstream roller 89a is changed. When the contact angle θ1 increases, the curl correction amount increases, and when the contact angle θ1 decreases, the curl correction amount decreases. The curl correction amount can be adjusted by changing the contact angle θ1 by adjusting the moving amount of the pair of movable rollers 83a and 83b in the upward direction U.

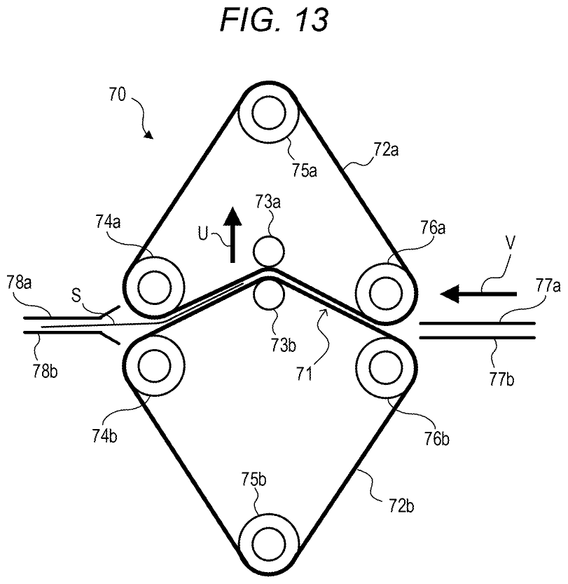

The sheet conveying path 81 is linearly maintained from the pair of downstream rollers 89a and 89b to the pair of downstream guides 88a and 88b. Since the sheet S of which curl has been corrected by the pair of downstream rollers 89a and 89b is conveyed through the linear sheet conveying path 81 to the pair of downstream guides 88a and 88b, deterioration in curl correcting ability is prevented. In the conventional curl correcting device 70 shown in FIG. 13, the curl correcting ability for the sheet S of which curl is corrected by the pair of pressing rollers 73a and 73b is reduced by the bending of the sheet conveying path 71 around the drive roller 74a or the driven roller 74b. On the other hand, in the curl correcting device 80 of the comparative example, since the sheet conveying path 81 is not bent by the drive roller 84a or the driven roller 84b, the deterioration in the curl correcting ability is prevented.

When the curl correction amount is increased, the moving amount Z of the pair of movable rollers 83a and 83b in the upward direction U or the downward direction D is increased in order to increase the contact angle θ1. However, as the moving amount Z increases, the time required to move the pair of movable rollers 83a and 83b by the moving amount Z increases. If the moving time of the pair of movable rollers 83a and 83b becomes long, productivity may be reduced in continuous image formation. For example, in a case in which the curl correction amount and the correction direction are different for each sheet in continuous image formation, since the pair of movable rollers 83a and 83b are moved during a time between the conveying sheet and the conveying sheet, the moving time becomes long so that the productivity decreases. In addition, even when an image is to be formed on one sheet, if there are a plurality of curls in different directions in the one sheet, it is necessary to move the pair of movable rollers 83a and 83b in different directions while the one sheet is conveyed through the curl correcting device 80. In this case, too, the moving time becomes long so that the productivity decreases.

### (Structure of Curl Correcting Device of First Embodiment)

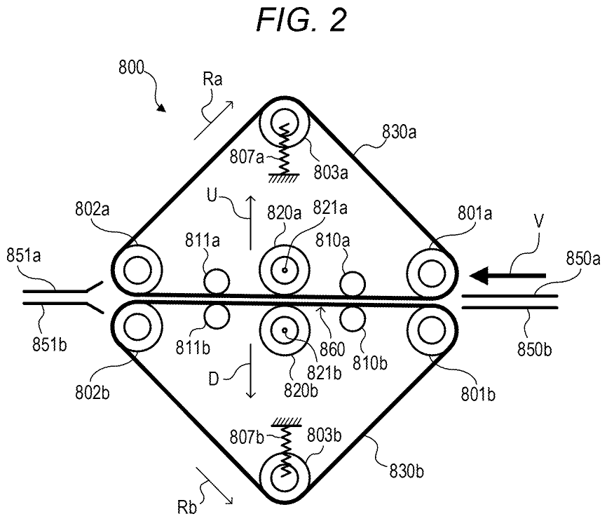

The curl correcting device 800 of the first embodiment is configured such that a moving amount Z of a pair of movable rollers 820a and 820b is smaller than the moving amount Z of the curl correcting device 80 of the comparative example. FIG. 2 is a view of the curl correcting device 800 of the first embodiment. The curl correcting device 800 has a pair of conveyance belts 830a and 830b that form a sheet conveying path 860 therebetween. The pair of conveyance belts 830a and 830b are disposed to be opposed to each other so as to define the sheet conveying path 860. The pair of conveyance belts 830a and 830b may be divided into a plurality of pieces in a front-back direction of the image forming apparatus 1. The curl correcting device 800 has a pair of movable rollers 820a and 820b disposed so as to sandwich the pair of conveyance belts 830a and 830b at an opposed portion in which the pair of conveyance belts 830a and 830b are opposed to each other.

The curl correcting device 800 includes a pair of inlet rollers 801a and 801b and a pair of outlet rollers 802a and 802b. The pair of movable rollers 820a and 820b are disposed between the pair of inlet rollers 801a and 801b and the pair of outlet rollers 802a and 802b. A pair of upstream rollers 810a and 810b are disposed between the pair of movable rollers 820a and 820b and the pair of inlet rollers 801a and 801b. A pair of downstream rollers 811a and 811b are disposed between the pair of movable rollers 820a and 820b and the pair of outlet rollers 802a and 802b.

The pair of conveyance belts 830a and 830b comprises a first conveyance belt 830a disposed on one side (upper side in FIG. 2) of the sheet conveying path 860 and a second conveyance belt 830b disposed on the other side (lower side in FIG. 2) of the sheet conveying path 860. With respect to a first movable roller 820a disposed on the one side of the sheet conveying path 860, a first support roller 803a configured to support the first conveyance belt 830a is provided on a side opposite to the sheet conveying path 860. With respect to the second movable roller 820b disposed on the other side of the sheet conveying path 860, a second support roller 803b configured to support the second conveyance belt 830b is provided on a side opposite to the sheet conveying path 860.

The first conveyance belt 830a is passed over a first inlet roller 801a, a first upstream roller 810a, the first movable roller 820a, a first downstream roller 811a, a first outlet roller 802a, and the first support roller 803a. The first conveyance belt 830a is rotatable in a rotation direction Ra indicated by the arrow. The second conveyance belt 830b is passed over a second inlet roller 801b, a second upstream roller 810b, the second movable roller 820b, a second downstream roller 811b, a second outlet roller 802b and the second support roller 803b. The second conveyance belt 830b is rotatable in a rotation direction Rb indicated by the arrow.

The pair of upstream rollers 810a and 810b are disposed so as to sandwich the pair of conveyance belts 830a and 830b upstream of the pair of movable rollers 820a and 820b in the sheet conveying direction V. The pair of downstream rollers 811a and 811b are disposed so as to sandwich the pair of conveyance belts 830a and 830b downstream of the pair of movable rollers 820a and 820b in the sheet conveying direction V. A diameter of the pair of upstream rollers 810a and 810b and a diameter of the pair of downstream rollers 811a and 811b are smaller than a diameter of the pair of movable rollers 820a and 820b. The diameter of the pair of upstream rollers 810a and 810b and the diameter of the pair of downstream rollers 811a and 811b are smaller than diameters of the first inlet roller 801a, the second inlet roller 801b, the first outlet roller 802a and the second outlet roller 802b. The pair of upstream rollers 810a and 810b and the pair of downstream rollers 811a and 811b may be, for example, hard rollers formed of metal.

The first support roller 803a and the second support roller 803b are configured to be movable in the upward direction (first direction) U and the downward direction (second direction) D, and function as a first tension roller and a second tension roller, respectively. However, the pair of support rollers 803a and 803b need not necessarily function as the pair of tension rollers, and may be configured not to move in the upward direction U and the downward direction D. The first support roller 803a is urged in the upward direction U by a compression spring (first urging member) 807a so as to apply tension to the first conveyance belt 830a. The second support roller 803b is urged in the downward direction D by a compression spring (second urging member) 807b so as to apply tension to the second conveyance belt 830b. The first support roller 803a and the second support roller 803b are configured to apply appropriate tensions to the first conveyance belt 830a and the second conveyance belt 830b even when the pair of movable rollers 820a and 820b are moved in the upward direction U or the downward direction D.

For example, if the diameters of the pair of inlet rollers 801a and 801b and the pair of outlet rollers 802a and 802b are larger than the diameters of the pair of movable rollers 820a and 820b, the first support roller 803a and the second support roller 803b may not be provided. If a moving area for the first movable roller 820a can be secured in a space inside the first conveyance belt 830a and a moving area for the second movable roller 820b can be secured in a space inside the second conveyance belt 830b, the pair of support rollers 803a and 803b can be omitted.

In the first embodiment, the first outlet roller 802a is used as one drive roller, and the first inlet roller 801a, the second inlet roller 801b, and the second outlet roller 802b are used as driven rollers. However, the position and the number of the drive roller are not limited thereto. The first inlet roller 801a, the second inlet roller 801b, or the second outlet roller 802b may function as a drive roller. At least one of the first inlet roller 801a, the second inlet roller 801b, the first outlet roller 802a, and the second outlet roller 802b may be a drive roller.

The sheet S conveyed in the sheet conveying direction V enters the sheet conveying path 860 formed between the pair of conveyance belts 830a and 830b from between the pair of upstream guides 850a and 850b. The sheet S is sandwiched between the rotating pair of conveyance belts 830a and 830b and conveyed through the sheet conveying path 860. The sheet S is conveyed in the sheet conveying direction V from between the pair of conveyance belts 830a and 830b to between the pair of downstream guides 851a and 851b.

Each of the pair of upstream rollers 810a and 810b and the pair of downstream rollers 811a and 811b is a small-diameter roller having a large curvature to correct the curl of the sheet S. The pair of upstream rollers 810a and 810b and the pair of downstream rollers 811a and 811b are fixed so as not to move in the upward direction (first direction) U and the downward direction (second direction) D, and are rotatable in accordance with the rotation of the pair of conveyance belts 830a and 830b. The pair of movable rollers 820a and 820b are movable in the upward direction (first direction) U and the downward direction (second direction) D orthogonal to the sheet conveying direction V and the rotation shafts 821a and 821b of the pair of movable rollers 820a and 820b. In order to correct the curl of the sheet S, the pair of movable rollers 820a and 820b having the diameter larger than the diameter of the pair of upstream rollers 810a and 810b and the pair of downstream rollers 811a and 811b are moved in the upward direction U or the downward direction D in accordance with the curl correction direction.

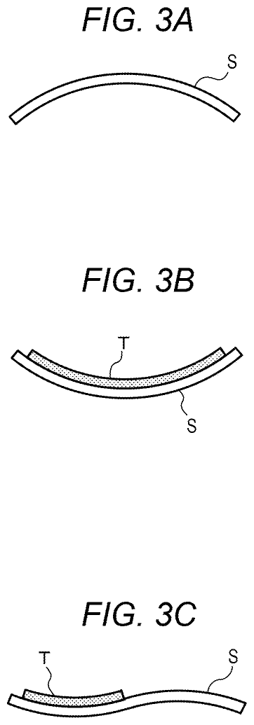

FIG. 3A, FIG. 3B, and FIG. 3C are explanatory views of curls occurring on sheets S. FIG. 3A is a view of a sheet S on which a heat curl has occurred. The heat curl is caused by a difference between a moisture state of the front surface and a moisture state of the back surface of the sheet S heated by the fixing device 58. The heat curl shown in FIG. 3A is a downward curl (first curl) in which the center portion is raised more than the both ends when the sheet S is placed horizontally. FIG. 3B is a view of a sheet S on which a toner curl has occurred. The toner curl is caused by a difference in the volume change rate with respect to the temperature change between the toner T and the sheet S when the sheet S on which the toner T is borne is heated by the fixing device 58 and then lowered in temperature. The toner curl shown in FIG. 3B is an upward curl (second curl) in which both ends of the sheet S are raised from the center when the sheet S is placed horizontally. FIG. 3C is a view of a sheet S on which both toner curl and sheet curl occur. The one sheet S shown in FIG. 3C has both upward curl and downward curl. In this way, a plurality of curls different in direction may occur on one sheet S.

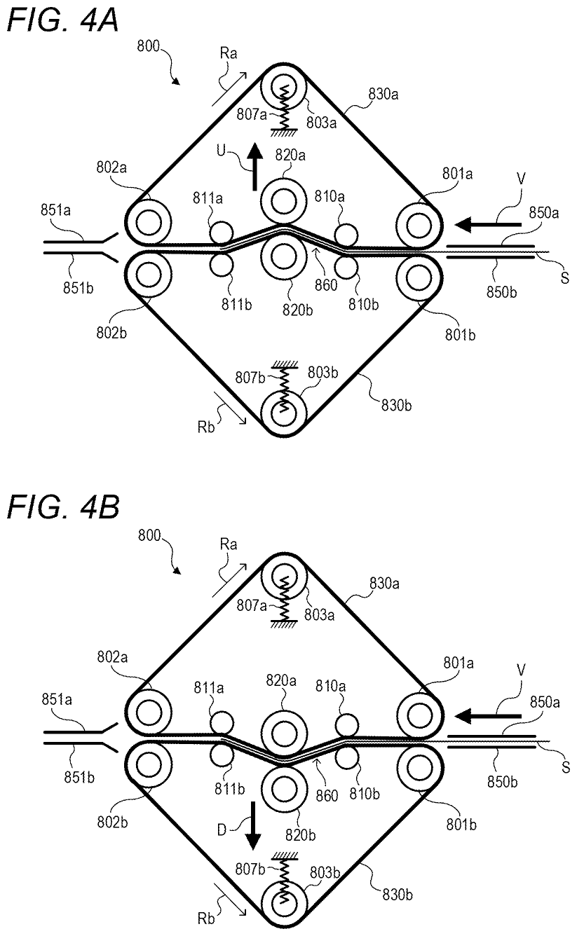

FIG. 4A and FIG. 4B are explanatory views of the movements of the pair of movable rollers 820a and 820b. FIG. 4A is a view of the curl correcting device 800 in which the pair of movable rollers 820a and 820b are moved in the upward direction U. When the sheet S having the downward curl as shown in FIG. 3A is corrected by the curl correcting device 800, the pair of movable rollers 820a and 820b are moved in the upward direction U as shown in FIG. 4A. The conveyance belts 830a and 830b are wound around the first upstream roller 810a and the first downstream roller 811a so that the sheet conveying path 860 is curved. The sheet S is conveyed through the curved sheet conveying path 860 and the upward curl is applied to the sheet S by the first upstream roller 810a and the first downstream roller 811a, so that the downward curl is corrected. The sheet conveying path 860 is maintained in a straight line from the pair of downstream rollers 811a and 811b to the pair of downstream guides 851a and 851b. Since the sheet S of which curl has been corrected by the first upstream roller 810a and the first downstream roller 811a is conveyed through the linear sheet conveying path 860 to the pair of downstream guides 851a and 851b, the deterioration in the curl correcting ability is prevented.

FIG. 4B is a view of the curl correcting device 800 in which the pair of movable rollers 820a and 820b are moved in the downward direction D. When the sheet S having the upward curl as shown in FIG. 3B is corrected by the curl correcting device 800, the pair of movable rollers 820a and 820b are moved in the downward direction D as shown in FIG. 4B. The conveyance belts 830a and 830b are wound around the second upstream roller 810b and the second downstream roller 811b so that the sheet conveying path 860 is curved. The sheet S is conveyed through the curved sheet conveying path 860 and the downward curl is applied to the sheet S by the second upstream roller 810b and the second downstream roller 811b, so that the upward curl is corrected. Since the sheet conveying path 860 is maintained in the straight line from the pair of downstream rollers 811a and 811b to the pair of downstream guides 851a and 851b, the deterioration in the curl correcting ability is prevented.

When the sheet S having both upward curl and downward curl as shown in FIG. 3C is corrected by the curl correcting device 800, the pair of movable rollers 820a and 820b are moved in the downward direction D and then moved in the upward direction U. The pair of movable rollers 820a and 820b are moved in the upward direction U or the downward direction D according to the direction of the curl occurring on the sheet S, and the moving amount Z is determined according to the curl amount.

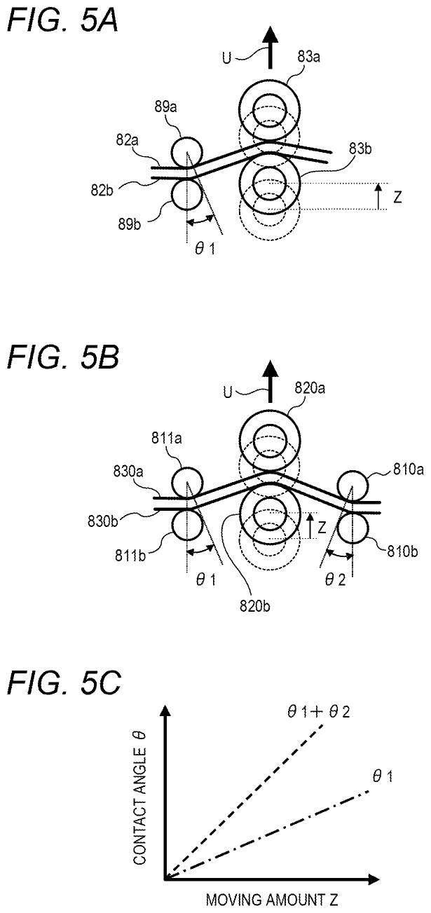

FIG. 5A, FIG. 5B, and FIG. 5C are explanatory views of the moving amount Z of the pair of movable rollers 820a and 820b (83a, 83b) and a contact angle θ of the conveyance belts 830a and 830b (82a, 82b). FIG. 5A is a view of the contact angle θ1 of the pair of conveyance belts 82a and 82b wound around the first downstream roller 89a of the curl correcting device 80 of the comparative example shown in FIG. 12A and FIG. 12B. FIG. 5B is a view of the contact angle θ1 of the pair of conveyance belts 830a and 830b wound around the first downstream roller 811a of the curl correcting device 800 of the first embodiment and a contact angle θ2 wound around the first upstream roller 810a. FIG. 5C is a graph showing a relationship between the moving amount Z of the pair of movable rollers 820a and 820b (83a, 83b) and the contact angle θ.

As can be seen from FIG. 5C, as the moving amount Z of the pair of movable rollers 83a and 83b in the upward direction U or the downward direction D increases, the contact angle θ1 of the pair of conveyance belts 82a and 82b wound around the first downstream roller 89a increases. That is, by increasing the moving amount Z of the pair of movable rollers 83a and 83b, the curl correcting ability can be increased. In the curl correcting device 800 of the first embodiment, the curl of the sheet S is corrected while the sheet S is conveyed through a conveyance section having the contact angle θ1 by which the pair of conveyance belts 830a and 830b are wound around the downstream roller 811a and the contact angle θ2 by which the sheet S is wound around the upstream roller 810a. Since the contact angle θ (=θ1+θ2) in the curl correcting device 800 of the first embodiment is twice as large as the contact angle θ1 in the curl correcting device 80 of the comparative example, the length of the conveyance section in which the curl correcting effect can be obtained is also twice as long. When the sheet S is conveyed at the same conveying speed in the curl correcting device 800 of the first embodiment and the curl correcting device 80 of the comparative example, the curl correcting time imparted to the sheet S by the curl correcting device 800 of the first embodiment is twice as much as the curl correcting time by the curl correcting device 80 of the comparative example.

As can be seen from FIG. 5C, in order that the curl correcting device 800 of the first embodiment obtains the same contact angle θ as that of the curl correcting device 80 of the comparative example, the moving amount Z of the pair of movable rollers 820a and 820b is half the moving amount Z in the curl correcting device 80 of the comparative example. That is, even if the moving amount Z of the pair of movable rollers 820a and 820b of the curl correcting device 800 of the first embodiment is smaller than that of the curl correcting device 80 of the comparative example, the curl correcting device 800 of the first embodiment can obtain a curl correcting ability equal to or greater than that of the curl correcting device 80 of the comparative example. By reducing the moving amount Z of the pair of movable rollers 820a and 820b, the time required for moving the pair of movable rollers 820a and 820b is shortened so that the productivity of the image forming apparatus 1 can be improved.

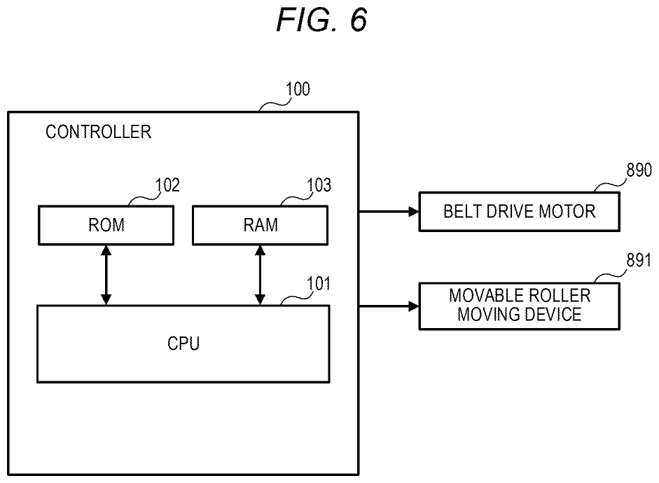

The image forming apparatus 1 is provided with a controller 100 configured to control the moving amount Z of the pair of movable rollers 820a and 820b. FIG. 6 is a block diagram of the controller 100 of the first embodiment. The controller 100 includes a CPU (central processing unit) 101, a ROM (read only memory) (storage device) 102, and a RAM (random access memory) (storage device) 103. The controller 100 is electrically connected to a belt drive motor 890 and a movable roller moving device (moving unit) 891. Referring to FIG. 2, the belt drive motor 890 rotates the first outlet roller 802a as the drive roller to rotate the conveyance belt 830a in the rotation direction Ra. The second conveyance belt 830b is rotated in the rotation direction Rb following the rotation of the first conveyance belt 830a. The movable roller moving device 891 moves the pair of movable rollers 820a and 820b in the upward direction U or the downward direction D in accordance with a control signal from the controller 100.

### (Operation of Curl Correcting Device of First Embodiment)

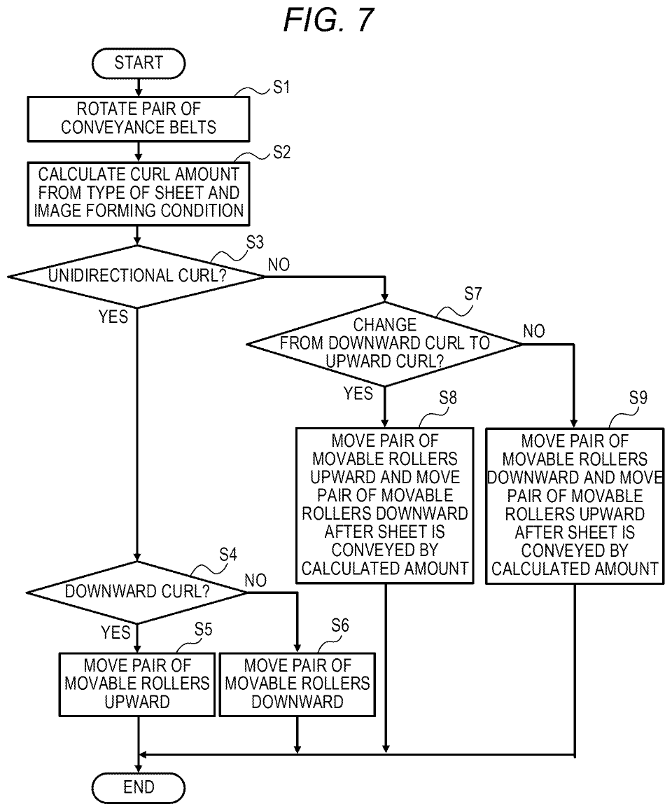

The operation of the curl correcting device 800 of the first embodiment will be described below with reference to FIG. 7. FIG. 7 is a flowchart illustrating the operation of the curl correcting device 800 of the first embodiment. The CPU 101 controls the operation of the curl correcting device 800 according to a control program stored in the ROM 102. The CPU 101 starts the rotation of the belt drive motor 890 to rotate the pair of conveyance belts 830a and 830b (S1). The CPU 101 calculates the amount of curl (curl amount) to occur on the sheet S from a type of the sheet S and an image forming condition (S2).

The CPU 101 determines whether or not the calculated curl amount represents a unidirectional curl (S3). In a case in which it is determined that the calculated curl amount represents the unidirectional curl (YES in S3), the CPU 101 determines whether the unidirectional curl is a downward curl (S4). In a case in which it is determined that the unidirectional curl is the downward curl (YES in S4), the CPU 101 controls the movable roller moving device 891 to move the pair of movable rollers 820a and 820b in the upward direction U (S5). As a result, as shown in FIG. 4A, the sheet conveying path 860 is curved upward by winding the pair of conveyance belts 830a and 830b around the first upstream roller 810a and the first downstream roller 811a. By passing the sheet S through the curved sheet conveying path 860, the sheet S is curled upward so as to correct the downward curl of the sheet S.

On the other hand, in a case in which it is determined that the unidirectional curl is an upward curl (NO in S4), the CPU 101 controls the movable roller moving device 891 to move the pair of movable rollers 820a and 820b in the downward direction D (S6). As a result, as shown in FIG. 4B, the sheet conveying path 860 is bent downward by winding the pair of conveyance belts 830a and 830b around the second upstream roller 810b and the second downstream roller 811b. By passing the sheet S through the curved sheet conveying path 860, the sheet S is curled downward so as to correct the upward curl of the sheet S. The moving amount Z of the pair of movable rollers 820a and 820b in the upward direction U or the downward direction D may be determined based on the calculated curl amount.

On the other hand, in a case in which it is determined that the curl amount calculated in S2 does not represent the unidirectional curl (NO in S3), the CPU 101 determines whether the calculated curl amount represents a change from a downward curl to an upward curl (S7). In a case in which it is determined that the calculated curl amount represents the change from the downward curl to the upward curl (YES in S7), the CPU 101 advances the process to S8. In this case, the downstream side of one sheet S curls downward, and the upstream side of the one sheet S curls upward. In S8, the CPU 101 moves the pair of movable rollers 820a and 820b in the upward direction U, and then moves the pair of movable rollers 820a and 820b in the downward direction D after the sheet is conveyed by a calculated amount. Thus, after the downward curl on the downstream side of the one sheet S is corrected, the upward curl on the upstream side of the one sheet S can be corrected.

On the other hand, in a case in which it is determined that the calculated curl amount represents a change from an upward curl to a downward curl (NO in S7), the CPU 101 advances the process to S9. In this case, the downstream side of one sheet S curls upward, and the upstream side of the one sheet S curls downward. In S9, the CPU 101 moves the pair of movable rollers 820a and 820b in the downward direction D, and then moves the pair of movable rollers 820a and 820b in the upward direction U after the sheet is conveyed by a calculated amount. Thus, after the upward curl on the downstream side of the one sheet S is corrected, the downward curl on the upstream side of the one sheet S can be corrected.

According to the first embodiment, the moving amount Z of the pair of movable rollers 820a and 820b configured to correct the curl of the sheet S can be reduced. Since the time required for moving the pair of movable rollers 820a and 820b is shortened, the productivity can be improved even in a case of correcting curls of a plurality of sheets S continuously conveyed or even in a case in which the correction direction and the correction amount for curls occurring on one sheet S change.

### Second Embodiment

Next, a second embodiment will be described. In the second embodiment, the same structures as those in the first embodiment are denoted by the same reference numerals, and the description thereof is omitted. The image forming apparatus 1 of the second embodiment is the same as that of the first embodiment, and therefore the description thereof is omitted. A curl correcting device (sheet conveying apparatus) 900 of the second embodiment is different from the curl correcting device 800 of the first embodiment. Hereinafter, differences from the first embodiment will be mainly described.

### (Structure of Curl Correcting Device of Second Embodiment)

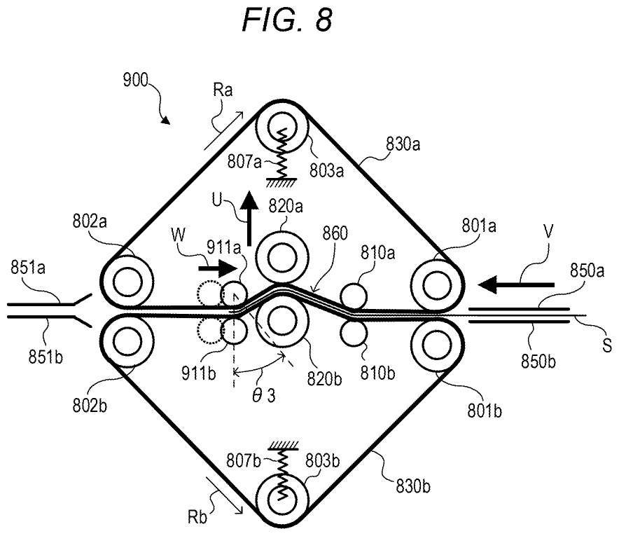

FIG. 8 is a view of the curl correcting device 900 of the second embodiment. The curl correcting device 900 of the second embodiment is similar to the curl correcting device 800 of the first embodiment except that a pair of downstream rollers 911a and 911b are movable in the sheet conveying direction (downstream direction) V and in a direction (upstream direction) W opposite to the sheet conveying direction V. In the curl correcting device 900 of the second embodiment, the same structures as those of the curl correcting device 800 of the first embodiment are denoted by the same reference numerals, and the description thereof is omitted.

For example, in a case in which the sheet S having the downward curl is to be corrected by the curl correcting device 900, as shown in FIG. 8, the pair of movable rollers 820a and 820b are moved in the upward direction U, and the pair of downstream rollers 911a and 911b are moved in the upstream direction W. The pair of conveyance belts 830a and 830b are wound around the first upstream roller 810a and the first downstream roller 911a, and the sheet conveying path 860 is curved. As a moving amount of the pair of downstream rollers 911a and 911b in the upstream direction W increases, a contact angle θ3 of the pair of conveyance belts 830a and 830b wound around the first downstream roller 911a increases. For example, in a case in which the moving amount Z of the pair of movable rollers 820a and 820b in the upward direction U is the same as in the first embodiment, the contact angle θ3 of the second embodiment is larger than the contact angle θ1 of the first embodiment (θ3>θ1). Therefore, according to the second embodiment, the moving amount Z of the pair of movable rollers 820a and 820b moved in the upward direction U to obtain the same contact angle θ1 as in the first embodiment can be reduced.

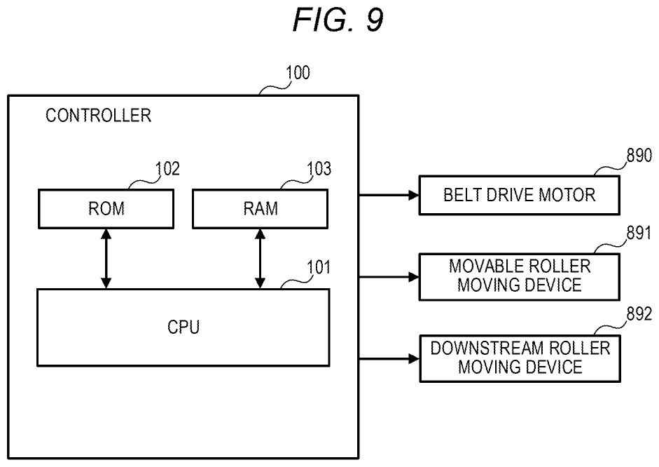

FIG. 9 is a block diagram of the controller 100 of the second embodiment. In the controller 100 of the second embodiment, the same structures as those of the first embodiment are denoted by the same reference numerals and the description thereof is omitted. The controller 100 is electrically connected to the belt drive motor 890, the movable roller moving device 891, and the downstream roller moving device (downstream roller moving unit) 892. The downstream roller moving device 892 moves the pair of downstream rollers 911a and 911b in the sheet conveying direction V and in the upstream direction W opposite to the sheet conveying direction V in accordance with a control signal from the controller 100.

### (Operation of Curl Correcting Device of Second Embodiment)

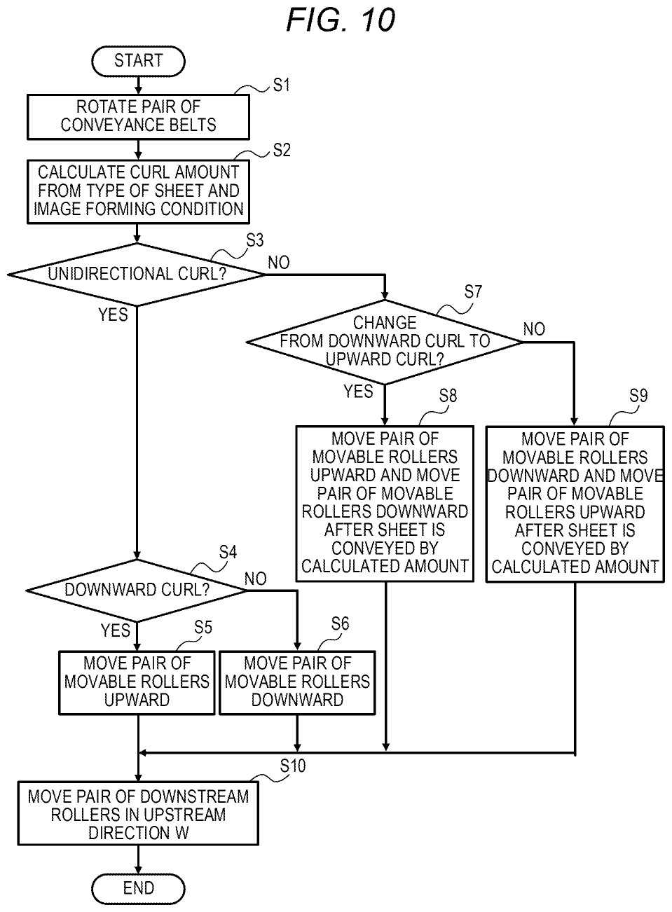

The operation of the curl correcting device 900 of the second embodiment will be described below with reference to FIG. 10. FIG. 10 is a flowchart illustrating the operation of the curl correcting device 900 of the second embodiment. The CPU 101 controls the operation of the curl correcting device 900 according to a control program stored in the ROM 102. In the flowchart of FIG. 10, the same steps as those in the flowchart of the first embodiment shown in FIG. 7 are denoted by the same step numbers and the description thereof is omitted. The steps S1 to S9 in FIG. 10 are the same as the steps S1 to S9 in FIG. 7, and therefore description thereof is omitted.

The CPU 101 controls the movable roller moving device 891 to move the pair of movable rollers 820a and 820b in the upward direction U or the downward direction D (S5, S6, S8, or S9). Thereafter, the CPU 101 controls the downstream roller moving device 892 to move the pair of downstream rollers 911a and 911b in the upstream direction W opposite to the sheet conveying direction V (S10). For example, when the pair of movable rollers 820a and 820b are moved in the upward direction U in S5, it is assumed that the pair of conveyance belts 830a and 830b are wound around the downstream roller 911a at the contact angle θ1. Thereafter, when the pair of downstream rollers 911a and 911b are moved in the upstream direction W by the downstream roller moving device 892 (S10), the pair of conveyance belts 830a and 830b are wound around the downstream roller 911a at the contact angle θ3 larger than the contact angle θ1. The curl correcting effect can be adjusted by adjusting the moving amount of the pair of downstream rollers 911a and 911b in the upstream direction W.

According to the second embodiment, the contact angle θ3 can be adjusted by adjusting the moving amount Z of the pair of movable rollers 820a and 820b by the movable roller moving device 891 and the moving amount of the pair of downstream rollers 911a and 911b by the downstream roller moving device 892. Therefore, the curl correcting ability of the curl correcting device 900 can be set to a desired value in a shorter time.

According to the second embodiment, the moving amount Z of the pair of movable rollers 820a and 820b configured to correct the curl of the sheet S can be reduced. Since the time required for moving the pair of movable rollers 820a and 820b is shortened, the productivity can be improved even in a case of correcting curls of a plurality of sheets S continuously conveyed or even in a case in which the correction direction and the correction amount for curls occurring on one sheet S change.

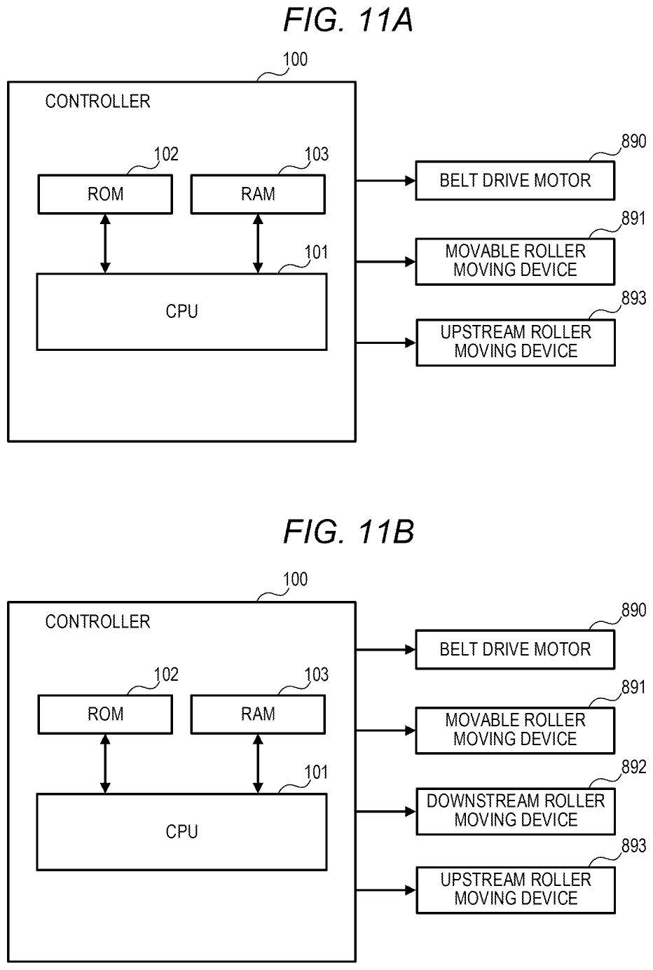

In the second embodiment, the pair of downstream rollers 911a and 911b are configured to be movable in the sheet conveying direction V and in the upstream direction W opposite to the sheet conveying direction V. However, the second embodiment is not limited thereto, and the pair of upstream rollers 810a and 810b may be configured to be movable in the sheet conveying direction V and in the upstream direction W opposite to the sheet conveying direction V. FIG. 11A and FIG. 11B are block diagrams of controllers 100 of modification examples of the second embodiment. As shown in FIG. 11A, the controller 100 may be electrically connected to an upstream roller moving device (upstream roller moving unit) 893 instead of the downstream roller moving device 892. Further, both the pair of downstream rollers 911a and 911b and the pair of upstream rollers 810a and 810b may be configured to be movable in the sheet conveying direction V and in the upstream direction W opposite to the sheet conveying direction V. In this case, as shown in FIG. 11B, the controller 100 may be electrically connected to the downstream roller moving device 892 and the upstream roller moving device 893.

In the second embodiment, after the pair of movable rollers 820a and 820b are moved by the movable roller moving device 891, the pair of downstream rollers 911a and 911b are moved by the downstream roller moving device 892. However, the order of movement of the pair of movable rollers 820a and 820b and movement of the pair of downstream rollers 911a and 911b is not limited thereto. After the pair of downstream rollers 911a and 911b are moved by the downstream roller moving device 892, the pair of movable rollers 820a and 820b may be moved by the movable roller moving device 891. Alternatively, the movement of the pair of movable rollers 820a and 820b by the movable roller moving device 891 and the movement of the pair of downstream rollers 911a and 911b by the downstream roller moving device 892 may be carried out in parallel.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-095600, filed Jun. 8, 2021, which is hereby incorporated by reference herein in its entirety.

What is claimed is:

1. A sheet conveying apparatus, comprising:
a pair of inlet rollers;
a pair of outlet rollers;
a pair of movable rollers disposed between the pair of inlet rollers and the pair of outlet rollers in a sheet conveying direction from the pair of inlet rollers toward the pair of outlet rollers, the pair of movable rollers being movable in a first direction orthogonal to the sheet conveying direction and rotation axes of the pair of movable rollers and in a second direction opposite to the first direction;
a moving unit configured to move the pair of movable rollers in the first direction and in the second direction;
a pair of upstream rollers disposed between the pair of inlet rollers and the pair of movable rollers in the sheet conveying direction;
a pair of downstream rollers disposed between the pair of movable rollers and the pair of outlet rollers in the sheet conveying direction;
a first conveyance belt passed over a first inlet roller of the pair of inlet rollers, a first outlet roller of the pair of outlet rollers, a first movable roller of the pair of movable rollers, a first upstream roller of the pair of upstream rollers, and a first downstream roller of the pair of downstream rollers; and
a second conveyance belt disposed opposite to the first conveyance belt to form a sheet conveying path and passed over a second inlet roller different from the first inlet roller of the pair of inlet rollers, a second outlet roller different from the first outlet roller of the pair of outlet rollers, a second movable roller different from the first movable roller of the pair of movable rollers, a second upstream roller different from the first upstream roller of the pair of upstream rollers, and a second downstream roller different from the first downstream roller of the pair of downstream rollers,
wherein a diameter of the pair of upstream rollers and a diameter of the pair of downstream rollers are smaller than a diameter of the pair of movable rollers.

2. The sheet conveying apparatus according to claim 1, further comprising a downstream roller moving unit configured to move the pair of downstream rollers in the sheet conveying direction and in an upstream direction opposite to the sheet conveying direction.

3. The sheet conveying apparatus according to claim 1, further comprising an upstream roller moving unit configured to move the pair of upstream rollers in the sheet conveying direction and in an upstream direction opposite to the sheet conveying direction.

4. The sheet conveying apparatus according to claim 1, further comprising:
a downstream roller moving unit configured to move the pair of downstream rollers in the sheet conveying direction and in an upstream direction opposite to the sheet conveying direction; and
an upstream roller moving unit configured to move the pair of upstream rollers in the sheet conveying direction and in the upstream direction.

5. The sheet conveying apparatus according to claim 1, further comprising:
a first support roller configured to support the first conveyance belt on a side opposite to the sheet conveying path with respect to the first movable roller; and
a second support roller configured to support the second conveyance belt on a side opposite to the sheet conveying path with respect to the second movable roller.

6. The sheet conveying apparatus according to claim 5, further comprising:
a first urging member configured to urge the first support roller so that the first support roller applies tension to the first conveyance belt; and
a second urging member configured to urge the second support roller so that the second support roller applies tension to the second conveyance belt.

7. The sheet conveying apparatus according to claim 1, wherein at least one of the first inlet roller, the second inlet roller, the first outlet roller, and the second outlet roller is a drive roller.

8. The sheet conveying apparatus according to claim 1, wherein the pair of upstream rollers are configured to be rotatable so as not to move in the first direction and in the second direction, and
wherein the pair of downstream rollers are configured to be rotatable so as not to move in the first direction and in the second direction.

9. The sheet conveying apparatus according to claim 1, wherein the pair of movable rollers are moved in the first direction or in the second direction to contact the first conveyance belt and the second conveyance belt so that the sheet conveying path between the pair of upstream rollers and the pair of downstream rollers in the sheet conveying direction is curved.

10. An image forming apparatus comprises:
an image forming portion configured to form a toner image on a sheet;
a fixing device configured to fix the toner image formed by the image forming portion to the sheet; and
a sheet conveying apparatus configured to convey the sheet to which the toner image is fixed by the fixing device, the sheet conveying apparatus, including:
a pair of inlet rollers;
a pair of outlet rollers;
a pair of movable rollers disposed between the pair of inlet rollers and the pair of outlet rollers in a sheet conveying direction from the pair of inlet rollers toward the pair of outlet rollers, the pair of movable rollers being movable in a first direction orthogonal to the sheet conveying direction and rotation axes of the pair of movable rollers and in a second direction opposite to the first direction;
a moving unit configured to move the pair of movable rollers in the first direction and in the second direction;
a pair of upstream rollers disposed between the pair of inlet rollers and the pair of movable rollers in the sheet conveying direction;
a pair of downstream rollers disposed between the pair of movable rollers and the pair of outlet rollers in the sheet conveying direction;
a first conveyance belt passed over a first inlet roller of the pair of inlet rollers, a first outlet roller of the pair of outlet rollers, a first movable roller of the pair of movable rollers, a first upstream roller of the pair of upstream rollers, and a first downstream roller of the pair of downstream rollers; and
a second conveyance belt disposed opposite to the first conveyance belt to form a sheet conveying path and passed over a second inlet roller different from the first inlet roller of the pair of inlet rollers, a second outlet roller different from the first outlet roller of the pair of outlet rollers, a second movable roller different from the first movable roller of the pair of movable rollers, a second upstream roller different from the first upstream roller of the pair of upstream rollers, and a second downstream roller different from the first downstream roller of the pair of downstream rollers,
wherein a diameter of the pair of upstream rollers and a diameter of the pair of downstream rollers are smaller than a diameter of the pair of movable rollers.

11. The image forming apparatus according to claim 10, further comprising a controller configured to calculating an amount of curl to occur on the sheet based on a type of the sheet and an image forming condition,
wherein in a case in which the controller determines, based on the amount of the curl, that a first curl in which a central portion of the sheet is raised in the first direction more than both end portions of the sheet occurs on the sheet, the controller moves the pair of movable rollers in the first direction by the moving unit, and
wherein in a case in which the controller determines, based on the amount of the curl, that a second curl in which the central portion of the sheet is raised in the second direction more than the both end portions of the sheet occurs on the sheet, the controller moves the pair of movable rollers in the second direction by the moving unit.
